(19) United States
(12) Patent Application Publication
(10) Pub. No.: US 2025/0123950 A1
(43) Pub. Date: Apr. 17, 2025

(54) GRAPH DATA GENERATION METHOD AND APPARATUS

(71) Applicant: Alipay (Hangzhou) Information Technology Co., Ltd., Hangzhou (CN)

(72) Inventor: Ke HUANG, Hangzhou (CN)

(21) Appl. No.: 18/568,506

(22) PCT Filed: May 19, 2022
(86) PCT No.: PCT/CN2022/093771

§ 371 Date: Dec. 8, 2023

(30) Foreign Application Priority Data
Jun. 24, 2021 (CN) 202110702337.7

(51) Int. Cl. G06F 11/3668

(52) U.S. Cl. CPC G06F 11/3688; G06F 11/3684

(57) ABSTRACT

Embodiments of this specification provide a method and an apparatus for generating graph data to be applied to a benchmark test. A plurality of entity vertices and corresponding entity account vertices of the entity vertices are created by using a vertex generation framework, and an owning relationship is created between the entity vertices and the corresponding entity account vertices. A start point entity account vertex set and an endpoint entity account vertex set are determined based on the created entity account vertices by using a vertex block framework, where there is no overlapping entity account vertex between the start point entity account vertex set and the endpoint entity account vertex set. Then, an account association relationship between the entity account vertices is created based on the start point entity account vertex set and the endpoint entity account vertex set by using a vertex relationship generation framework.

### TECHNICAL FIELD

Embodiments of this specification usually relate to the field of benchmark tests, and in particular, to a method and an apparatus for generating graph data to be applied to a benchmark test.

### BACKGROUND

As graph computing technologies gradually become mature, graph databases and graph computing are increasingly widely applied to the financial, customer service, medical, and other fields, especially the financial field. Before an application implemented based on graph data is put into use, a benchmark test needs to be performed on the application by using the graph data, and only an application that passes the benchmark test is allowed to be put into use. Therefore, how to efficiently generate the graph data for the benchmark test becomes an urgent problem to be resolved.

### SUMMARY

In view of the foregoing, embodiments of this specification provide a method and an apparatus for generating graph data to be applied to a benchmark test. By using the method and the apparatus, graph data for a benchmark test can be efficiently generated.

According to an aspect of the embodiments of this specification, a method for generating graph data to be applied to a benchmark test is provided, and includes: creating a plurality of entity vertices and corresponding entity account vertices of the entity vertices; creating an owning relationship between the entity vertices and the corresponding entity account vertices; determining a start point entity account vertex set and an endpoint entity account vertex set based on the created entity account vertices, where there is no overlapping entity account vertex between the start point entity account vertex set and the endpoint entity account vertex set; and creating an account association relationship between the entity account vertices based on the start point entity account vertex set and the endpoint entity account vertex set.

In an example of the aspect, an account vertex attribute of each entity account vertex includes an account association attribute, and the method can further include: creating an account attribute vertex based on the account association attribute of each entity account vertex; and creating an account attribute relationship between account attribute vertices and/or between each account attribute vertex and a corresponding entity account vertex based on the account association attribute.

In an example of the aspect, the entity vertex includes a personal vertex and an organizational vertex, the entity account vertex includes a personal account vertex and an organizational account vertex, and the account attribute vertex includes at least one of an account registration address, a registration phone, a login network address, and a login physical address; and the account attribute relationship includes at least one of a location relationship, a phone registration relationship, a login network address relationship, and a login physical address relationship.

In an example of the aspect, the method can further include: obtaining vertex outdegree distribution information of the entity vertices. In addition, the creating corresponding entity account vertices of the entity vertices can include: creating the corresponding entity account vertices of the entity vertices based on the vertex outdegree distribution information.

In an example of the aspect, an account vertex attribute of each entity account vertex includes a vertex outdegree and a vertex indegree, and the creating an account association relationship between the entity account vertices based on the start point entity account vertex set and the endpoint entity account vertex set can include: determining a selection probability of each start point entity account vertex in the start point entity account vertex set and a selection probability of each endpoint entity account vertex in the endpoint entity account vertex set based on a vertex outdegree of each start point entity account vertex and a vertex indegree of each endpoint entity account vertex; selecting at least one start point entity account vertex and a corresponding endpoint entity account vertex from the start point entity account vertex set and the endpoint entity account vertex set based on the selection probability of each start point entity account vertex and the selection probability of each endpoint entity account vertex; calculating an attribute distance between the selected start point entity account vertex and corresponding endpoint entity account vertex; determining a relationship creation probability between the selected start point entity account vertex and corresponding endpoint entity account vertex based on the calculated attribute distance; and creating an account association relationship between the selected start point entity account vertex and corresponding endpoint entity account vertex based on the relationship creation probability.

In an example of the aspect, a process of creating the account association relationship is cyclically performed until no new account association relationship is created, and a relationship creation probability used in each cycle process is obtained by performing attenuation processing on a relationship creation probability in a previous cycle process.

In an example of the aspect, a process of selecting the start point entity account vertex and the corresponding endpoint entity account vertex and a process of creating the account association relationship are cyclically performed until a quantity of created account association relationships reaches a predetermined quantity.

In an example of the aspect, the method can further include: obtaining vertex outdegree/indegree distribution information of the entity account vertex; and determining the vertex outdegree and the vertex indegree of each entity account vertex based on the vertex outdegree/indegree distribution information.

In an example of the aspect, the method can further include: obtaining social network outdegree/indegree distribution information; and creating a cognition/dependency relationship between the entity vertices based on the social network outdegree/indegree distribution information. In addition, the determining a relationship creation probability between the selected start point entity account vertex and endpoint entity account vertex based on the calculated attribute distance can include: determining the relationship creation probability between the selected start point entity account vertex and endpoint entity account vertex based on the calculated attribute distance and a cognition/dependency relationship between entity vertices to which the selected start point entity account vertex and endpoint entity account vertex respectively belong.

In an example of the aspect, the creating the corresponding entity account vertices of the plurality of entity vertices based on the vertex outdegree distribution information can include: creating the corresponding entity account vertices and service application vertices of the entity vertices based on the vertex outdegree distribution information; and creating an application relationship between each service application vertex and a corresponding entity vertex.

In an example of the aspect, the method can further include: extracting a plurality of first entity vertices from the plurality of entity vertices. In addition, the creating corresponding entity account vertices of the entity vertices can include: creating corresponding entity account vertices of the first entity vertices.

According to another embodiment of this specification, a method for generating graph data to be applied to a benchmark test is provided, and includes: separately creating a plurality of entity vertices by using each vertex generation framework; extracting a plurality of first entity vertices from the created entity vertices for each vertex generation framework by using a vertex block framework; separately creating corresponding entity account vertices of the extracted first entity vertices by using each vertex generation framework, and creating an owning relationship between each entity account vertex and a corresponding entity vertex; extracting a start point entity account vertex set and an endpoint entity account vertex set from the created entity account vertices for each vertex relationship generation framework by using the vertex block framework; and separately creating an account association relationship between the entity account vertices based on the extracted start point entity account vertex set and endpoint entity account vertex set by using each vertex relationship generation framework.

In an example of the aspect, an account vertex attribute of each entity account vertex includes an account association attribute, and the method can further include: creating an account attribute vertex based on the account association attribute of each entity account vertex by using each vertex generation framework; and creating an account attribute relationship between account attribute vertices and between each account attribute vertex and a corresponding entity account vertex based on the account association attribute.

In an example of the aspect, an entity vertex extraction process performed by the vertex block framework and an account association relationship creation process performed by each vertex relationship generation framework are cyclically performed.

In an example of the aspect, a vertex extraction process performed by the vertex block framework is an extraction process without replacement, and ends when all vertices are extracted.

In an example of the aspect, an account vertex attribute of each entity account vertex includes a vertex outdegree and a vertex indegree; and the creating an account association relationship between the entity account vertices based on the start point entity account vertex set and the endpoint entity account vertex set by using each vertex relationship generation framework can include: determining a selection probability of each start point entity account vertex in the start point entity account vertex set and a selection probability of each endpoint entity account vertex in the endpoint entity account vertex set based on a vertex outdegree of each start point entity account vertex and a vertex indegree of each endpoint entity account vertex; and cyclically performing the following process until a quantity of created account association relationships reaches a first predetermined quantity M: selecting at least one start point entity account vertex and a corresponding endpoint entity account vertex from the start point entity account vertex set and the endpoint entity account vertex set based on the selection probability of each start point entity account vertex and the selection probability of each endpoint entity account vertex; calculating an attribute distance between the selected start point entity account vertex and endpoint entity account vertex; determining a relationship creation probability between the selected start point entity account vertex and endpoint entity account vertex based on the calculated attribute distance; and creating an account association relationship between the selected start point entity account vertex and endpoint entity account vertex based on the relationship creation probability.

In an example of the aspect, the first predetermined quantity is M=P/K, where P is a total quantity of outdegrees of the plurality of entity account vertices, and K is a quantity of cyclic execution times.

In an example of the aspect, a process of creating the account association relationship is cyclically performed until no new account association relationship is created, and a relationship creation probability used in each cycle process is obtained by performing attenuation processing on a relationship creation probability in a previous cycle process.

In an example of the aspect, the method can further include: obtaining vertex outdegree/indegree distribution information of the entity account vertex by using a corresponding data distribution interface of each vertex generation framework; and determining the vertex outdegree and the vertex indegree of each entity account vertex based on the obtained vertex outdegree/indegree distribution information by using each vertex generation framework.

In an example of the aspect, the method can further include: obtaining social network outdegree/indegree distribution information by using a corresponding data distribution interface of each vertex generation framework; and creating a cognition/dependency relationship between the entity vertices based on the obtained social network outdegree/indegree distribution information by using each vertex generation framework. In addition, the determining a relationship creation probability between the selected start point entity account vertex and endpoint entity account vertex based on the calculated attribute distance can include: determining the relationship creation probability between the selected start point entity account vertex and endpoint entity account vertex based on the calculated attribute distance and a cognition/dependency relationship between entity vertices to which the selected start point entity account vertex and endpoint entity account vertex respectively belong.

In an example of the aspect, the method can further include: obtaining vertex outdegree distribution information of the entity vertices by using a corresponding data distribution interface of each vertex generation framework; and determining vertex outdegrees of the entity vertices based on the obtained vertex outdegree distribution information by using each vertex generation framework. In addition, the separately creating corresponding entity account vertices of the extracted first entity vertices by using each vertex generation framework can include: separately creating the corresponding entity account vertices of the first entity vertices based on vertex outdegrees of the extracted first entity vertices by using each vertex generation framework.

According to another aspect of the embodiments of this specification, an apparatus for generating graph data to be applied to a benchmark test is provided, and includes: a vertex generation unit, configured to create a plurality of entity vertices and corresponding entity account vertices of the entity vertices; an owning relationship generation unit, configured to create an owning relationship between the entity vertices and the corresponding entity account vertices; a vertex block unit, configured to determine a start point entity account vertex set and an endpoint entity account vertex set based on the created entity account vertices, where there is no overlapping entity account vertex between the start point entity account vertex set and the endpoint entity account vertex set; and an association generation unit, configured to create an account association relationship between the entity account vertices based on the start point entity account vertex set and the endpoint entity account vertex set.

According to another aspect of the embodiments of this specification, an apparatus for generating graph data to be applied to a benchmark test is provided, and includes: at least two vertex generation frameworks, where each vertex generation framework is deployed at one first device; at least two vertex relationship generation frameworks, where each vertex relationship generation framework is deployed at one second device; and a vertex block framework, deployed at a third device. Each vertex generation framework is configured to create a plurality of entity vertices; create corresponding entity account vertices of first entity vertices extracted by the vertex block framework; and create an owning relationship between each entity account vertex and a corresponding entity vertex. The vertex block framework is configured to extract the plurality of first entity vertices from the created entity vertices for each vertex generation framework; and extract a start point entity account vertex set and an endpoint entity account vertex set from the created entity account vertices for each vertex relationship generation framework. Each vertex relationship generation framework is configured to create an account association relationship between the entity account vertices based on the extracted start point entity account vertex set and endpoint entity account vertex set.

In an example of the aspect, the apparatus can further include a data distribution interface deployed at each first device, configured to obtain vertex outdegree information; and vertex outdegrees of the entity vertices are determined based on the corresponding vertex outdegree distribution information.

In an example of the aspect, an account vertex attribute of each entity account vertex includes a vertex outdegree and a vertex indegree. Each vertex relationship generation framework is configured to determine a selection probability of each start point entity account vertex in the start point entity account vertex set and a selection probability of each endpoint entity account vertex in the endpoint entity account vertex set based on a vertex outdegree of each start point entity account vertex and a vertex indegree of each endpoint entity account vertex; and cyclically perform the following process until a quantity of created account association relationships reaches a first predetermined quantity M: selecting at least one start point entity account vertex and a corresponding endpoint entity account vertex from the start point entity account vertex set and the endpoint entity account vertex set based on the selection probability of each start point entity account vertex and the selection probability of each endpoint entity account vertex; calculating an attribute distance between the selected start point entity account vertex and endpoint entity account vertex; determining a relationship creation probability between the selected start point entity account vertex and endpoint entity account vertex based on the calculated attribute distance; and creating an account association relationship between the selected start point entity account vertex and endpoint entity account vertex based on the relationship creation probability.

In an example of the aspect, the apparatus can further include a data distribution interface deployed at each first device, configured to obtain vertex outdegree/indegree distribution information of the entity account vertex; and the vertex outdegree and the vertex indegree of each entity account vertex are determined based on the corresponding vertex outdegree/indegree distribution information.

In an example of the aspect, the apparatus can further include a data distribution interface deployed at each first device, configured to obtain social network outdegree/indegree distribution information; each vertex generation framework creates a cognition/dependency relationship between the entity vertices based on the obtained social network outdegree/indegree distribution information; and determines the relationship creation probability between the selected start point entity account vertex and endpoint entity account vertex based on the calculated attribute distance and a cognition/dependency relationship between entity vertices to which the selected start point entity account vertex and endpoint entity account vertex respectively belong.

In an example of the aspect, some or each of a plurality of first devices is the same as one of a plurality of second devices, and/or the third device is the same as one of the plurality of first devices and/or the plurality of second devices.

According to another aspect of the embodiments of this specification, a system for generating graph data to be applied to a benchmark test is provided, and includes: at least two first devices, where a vertex generation framework is deployed at each first device; at least two second devices, where a vertex relationship generation framework is deployed at each second device; and a third device at which a vertex block framework is deployed. Each vertex generation framework is configured to create a plurality of entity vertices; create corresponding entity account vertices of first entity vertices extracted by the vertex block framework; and create an owning relationship between each entity account vertex and a corresponding entity vertex. The vertex block framework is configured to extract the plurality of first entity vertices from the created entity vertices for each vertex generation framework; and extract a start point entity account vertex set and an endpoint entity account vertex set from the created entity account vertices for each vertex relationship generation framework. Each vertex relationship generation framework is configured to create an account association relationship between the entity account vertices based on the extracted start point entity account vertex set and endpoint entity account vertex set.

According to another aspect of the embodiments of this specification, an apparatus for generating graph data to be applied to a benchmark test is provided, and includes at least one processor, a storage coupled to the at least one processor, and a computer program stored in the storage. The at least one processor executes the computer program to implement the foregoing method.

According to another aspect of the embodiments of this specification, a computer-readable storage medium is provided. The computer-readable storage medium stores executable instructions. When the instructions are executed, a processor is enabled to perform the foregoing method.

According to another aspect of the embodiments of this specification, a computer program product is provided, and includes a computer program. The computer program is executed by a processor to implement the foregoing method.

### BRIEF DESCRIPTION OF DRAWINGS

The essence and advantages of the content of this specification can be further understood with reference to the following accompanying drawings. In the accompanying drawings, similar components or features can have the same reference numerals.

FIG. 1 is an example flowchart of a graph data generation method according to a first embodiment of this specification;

FIG. 2 is an example flowchart of an account association relationship creation process according to a first embodiment of this specification;

FIG. 3 is another example flowchart of an account association relationship creation process according to a first embodiment of this specification;

FIG. 4 is an example schematic diagram of a graph data generation process according to a first embodiment of this specification;

FIG. 5 is an example schematic diagram of a data structure of graph data according to a first embodiment of this specification;

FIG. 6 is a block diagram of an apparatus for generating graph data to be applied to a benchmark test according to a first embodiment of this specification;

FIG. 7 is a block diagram of a system for generating graph data to be applied to a benchmark test according to a second embodiment of this specification;

FIG. 8 is an example flowchart of a graph data generation method according to a second embodiment of this specification;

FIG. 9 is an example flowchart of an account association relationship creation process according to a second embodiment of this specification;

FIG. 10 is a block diagram of a graph data generation apparatus according to a second embodiment of this specification;

FIG. 11 is an example block diagram of a vertex generation framework according to a second embodiment of this specification;

FIG. 12 is an example block diagram of a vertex relationship generation framework according to a second embodiment of this specification; and

FIG. 13 is an example schematic diagram of a graph data generation apparatus implemented based on a computer system according to an embodiment of this specification.

### DESCRIPTION OF EMBODIMENTS

The subject matter described in this specification is described here with reference to example implementations. It should be understood that these implementations are described only to enable a person skilled in the art to better understand and implement the subject matter described in this specification, and are not intended to limit the protection scope, applicability, or examples described in the claims. The functions and arrangements of the described elements can be changed without departing from the protection scope of the content of this specification. Based on a requirement, the examples can be omitted or replaced, or various processes or components can be added. For example, the described method can be performed in a sequence different from the described sequence, and the steps can be added, omitted, or combined. In addition, features described relative to some examples can be combined in other examples.

As used in this specification, the term “including” and variants thereof represent open terms, and mean “including but not limited to”. The term “based on” means “at least partially based on”. The terms “one embodiment” and “an embodiment” mean “at least one embodiment”. The term “another embodiment” means “at least one other embodiment”. The terms “first”, “second”, and the like can refer to different or the same objects. Other definitions can be included below, either explicitly or implicitly. Unless explicitly stated in the context, the definition of a term is consistent throughout the specification.

Before an application implemented based on graph data is put into use, a benchmark test needs to be performed on the application by using the graph data, and only an application that passes the benchmark test is allowed to be put into use. The benchmark test is a quantitative and comparable test that is of a performance indicator of a type of test object and that is implemented by using a scientifically designed test method, test tool, and test system. For example, a benchmark test of indicators such as a floating-point operation, data access bandwidth, and a delay is performed on a computer CPU, so that a user can clearly understand whether operation performance and an operation throughput capability of each CPU meet a requirement of an application. A benchmark test of performance indicators such as atomicity, consistency, isolation, and durability (ACID), a query time, and online transaction processing a capability of a database management system is performed, to help a user select a database system that best meets a requirement of the user.

LDBC SNB DATAGEN proposed by the Linked Data Benchmark Council (LDBC) is a social network benchmark (SNB). A data size range generated by LDBC SNB DATAGEN is 100 MB-1 TB. However, data scenarios generated by LDBC SNB DATAGEN are too customized to be easily modified, and relatively greatly differ from requirements of some application scenarios (for example, financial application scenarios). In addition, in LDBC SNB DATAGEN, an attribute distance between two vertex attributes is used as a factor that affects a relationship creation probability, and relationship generation logic is relatively simple. Furthermore, in the LDBC SNB DATAGEN solution, when vertices are grouped during relationship generation due to a factor such as a computer hardware physical bottleneck, a relationship cannot be generated between vertices in blocks.

In view of the foregoing, embodiments of this specification provide a solution for generating graph data to be applied to a benchmark test. In this solution, a plurality of entity vertices and corresponding entity account vertices of the entity vertices are created by using a vertex generation framework, and an owning relationship is created between the entity vertices and the corresponding entity account vertices. A start point entity account vertex set and an endpoint entity account vertex set are determined based on the created entity account vertices by using a vertex block framework, where there is no overlapping entity account vertex between the start point entity account vertex set and the endpoint entity account vertex set. Then, an account association relationship between the entity account vertices is created based on the start point entity account vertex set and the endpoint entity account vertex set by using a vertex relationship generation framework.

In this specification, the term “account” refers to a carrier used to reflect a change in asset data and a result of the change, for example, a financial asset account, a digital asset account, or another type of data asset account. The term “account data” can include financial asset data (for example, fund data, debit/credit data, and liability data), digital asset data, another type of asset data, or the like. The term “account association relationship” is all types of relationships that may occur between two accounts, for example, an account data transfer relationship, an account binding relationship, an account dependency relationship, and another type of association relationship that can occur between accounts.

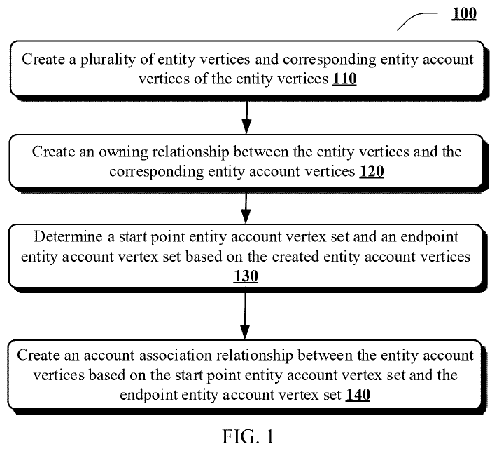

The graph data generation system, method, and apparatus according to the embodiments of this specification are described below with reference to FIG. 1 to FIG. 12.

FIG. 1 is an example flowchart of a graph data generation method 100 according to a first embodiment of this specification. The graph data generation method shown in FIG. 1 is performed by a graph data generation apparatus. Components of the graph data generation apparatus can be deployed at the same device or different devices.

As shown in FIG. 1, in 110, a plurality of entity vertices and corresponding entity account vertices of the entity vertices are created. In an example, each entity vertex can have an entity vertex attribute. The entity vertex attribute can include a vertex outdegree. Correspondingly, the corresponding entity account vertices can be created based on vertex outdegrees of the entity vertices. In addition, the entity vertex attribute can include an entity identifier. The entity identifier is used to uniquely identify the entity vertex. The entity identifier can be, for example, a globally unique identifier, for example, a globally unique integer created based on a corresponding block number. In an example (for example, an example of a financial application scenario), an entity can include a personal entity and an organizational entity. Correspondingly, the entity vertex can include a personal vertex (Person) and an organizational vertex (Organization). In an example, the vertex outdegrees of the entity vertices can be preset fixed values. In another example, the vertex outdegrees of the entity vertices can be determined based on, for example, vertex outdegree distribution information input by using a data distribution interface. For example, an integer can be randomly generated based on the vertex outdegree distribution information (for example, power-law distribution). In another example, the entity vertex attribute can further include a vertex indegree. Correspondingly, the vertex outdegrees and vertex indegrees of the entity vertices can be preset, or can be determined based on, for example, vertex outdegree/indegree distribution information input by using a data distribution interface. In addition, the entity vertex attribute can further include an entity name. For example, when the entity vertex is a personal vertex, the entity name can include a first name (First Name) and a last name (Last Name); or when the entity vertex is an organizational vertex, the entity name can include an organization name (Organization Name).

In an example, the created entity account vertex can include a personal account vertex (PersonalAccount) and an organizational account vertex (OrganizationalAccount). In addition, in an example, an account vertex attribute of each entity account vertex can include a vertex identifier, an account creation date (CreateDate), and an account validity identifier (IsBlocked). The account validity identifier IsBlocked can be represented by a Boolean value (Boolean), to indicate whether an account is valid. For example, a Boolean value “1” can be used to represent valid, and a Boolean value “0” can be used to represent invalid. In another example, a Boolean value “1” can be used to represent invalid, and a Boolean value “0” can be used to represent valid. In an example, a value DateTime of CreateDate can be generated within a limited time range by using a random generator, and a value of IsBlocked can be generated by using a random generator.

In addition, in another example, for the entity vertices, service application vertices can be further created. A specific form of the service application vertex can be determined based on a specific application scenario. For example, in a financial application scenario, an example of the service application vertex can include a loan application (LoanApplication) vertex or a financing application vertex. An entity vertex attribute of the LoanApplication vertex can have a vertex identifier and LoanAmount. A value of LoanAmount is a decimal value. Correspondingly, the corresponding entity account vertices and the service application vertices can be created for the entity vertices based on the vertex outdegrees of the entity vertices. Here, for example, the entity account vertex and the service application vertex can be collectively referred to as an entity-associated vertex.

In 120, an owning relationship (Owe) is created between the entity vertices and the corresponding entity account vertices. In another example, when a service application vertex is further created, in addition to creating an owning relationship between each entity account vertex and a corresponding entity vertex, an application relationship (Apply) can be further created between each service application vertex and a corresponding entity vertex. The application relationship can further have a relationship attribute (ApplyDate). A value of ApplyDate is generated within a limited time range by using a random generator.

In another example, each entity account vertex can further have an account vertex attribute. The account vertex attribute can include an account association attribute. When the entity account vertex includes a personal account vertex (PersonalAccount) and an organizational account vertex (OrganizationalAccount), an example of the account association attribute can include, for example, but is not limited to an account registration address, a registration phone (Phone), a login network address (IP), and a login physical address (MAC). The account registration address can be, for example, an account registration city (City). The login network address (IP) can be, for example, an IP address used to log in to an account. The login physical address (MAC) can be a device physical address of a device used to log in to the account, for example, a MAC address.

A registration phone (Phone), a login network address (IP), a login physical address (MAC), and a registration address (City) of a personal account PersonalAccount or an organizational account OrganizationalAccount are created when the personal account or the organizational account is created. A value of City is randomly extracted from a city data resource library. A value of Phone is randomly extracted from a phone data resource library. A quantity of IP addresses is generated by using a random generator, and then the corresponding quantity of IP addresses are randomly extracted from a network address data resource library. A quantity of MAC addresses is generated by using a random generator, and then the corresponding quantity of MAC addresses are randomly extracted from a physical address data resource library.

In an example, when the entity account vertex has an account association attribute, an account attribute vertex can be further created based on an account association attribute of each entity account vertex; and an account attribute relationship is created between account attribute vertices and between each account attribute vertex and a corresponding entity account vertex based on the account association attribute. For example, an example of the account attribute relationship can include but is not limited to at least one of a location relationship (IsLocatedIn), a phone registration relationship (SignUpDate), a login network address relationship (SignInWithIP), and a login physical address relationship (SignInWithMAC). For example, an account attribute relationship SignInWithIP is created between PersonalAccount and IP of the account attribute vertex, and the account attribute relationship has a relationship attribute SignInDate. A value of SignInDate is generated within a limited time range by using a random generator. An account attribute relationship SignInWithMAC is created between PersonalAccount and MAC of the account attribute vertex, and the account attribute relationship has a relationship attribute SignInDate. A value of SignInDate is generated within a limited time range by using a random generator. An account attribute relationship SignUpWithPhone is created between PersonalAccount and Phone of the account attribute vertex, and the account attribute relationship has a relationship attribute SignUpDate. A value of SignUpDate is generated within a limited time range by using a random generator. An account attribute relationship IsLocatedIn is created between PersonalAccount and City of the account attribute vertex. An account attribute relationship IsLocatedIn is created between Phone of the account attribute vertex and City of the account attribute vertex.

As described above, after the entity account vertex is created, in 130, a start point entity account vertex set and an endpoint entity account vertex set are determined based on the created entity account vertices. There is no overlapping entity account vertex between the start point entity account vertex set and the endpoint entity account vertex set. In this specification, a start point entity account vertex is used as a start point of an edge relationship of graph data, and an endpoint entity account vertex is used as an endpoint of the edge relationship of the graph data. In an example, the created entity account vertices can be classified into the start point entity account vertex set and the endpoint entity account vertex set. In another example, the start point entity account vertex set and the endpoint entity account vertex set can be extracted from the created entity account vertices. In this specification, the graph data is directed graph data.

In 140, an account association relationship is created between the entity account vertices based on the start point entity account vertex set and the endpoint entity account vertex set, to create required graph data. In this specification, an example of an account association relationship between two accounts can include, for example, but is not limited to an account data transfer relationship, an account binding relationship, and another type of association relationship that can occur between accounts. An example of the account data transfer relationship can include but is not limited to an account fund transfer relationship, a debit/credit data transfer relationship, and a liability data transfer relationship. In an example, the created graph data can be financial graph data, and the account association relationship can be a transfer relationship.

In an example, for the graph data generation method shown in FIG. 1, a plurality of first entity vertices can be further extracted from the plurality of entity vertices. Then, corresponding entity account vertices of the extracted first entity vertices are created.

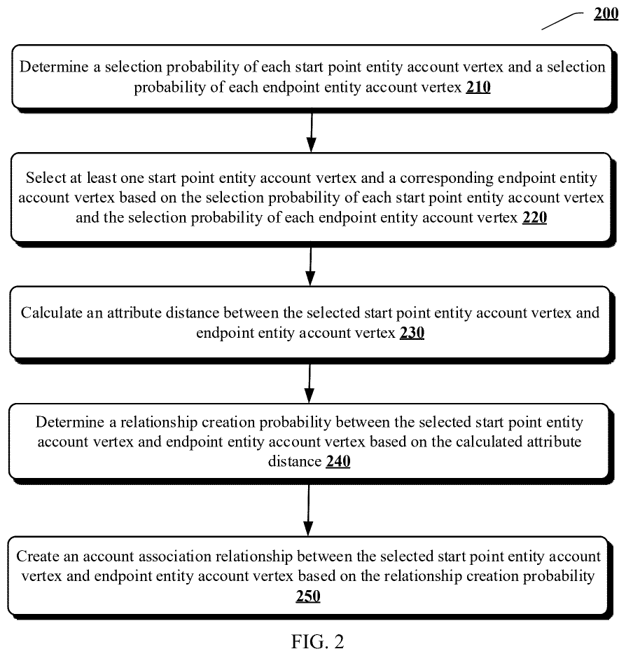

FIG. 2 is an example flowchart of an account association relationship creation process 200 according to a first embodiment of this specification. In an example in FIG. 2, an account vertex attribute of the entity account vertex includes a vertex outdegree and a vertex indegree.

As shown in FIG. 2, in 210, a selection probability of each start point entity account vertex in the start point entity account vertex set and a selection probability of each endpoint entity account vertex in the endpoint entity account vertex set are determined based on a vertex outdegree of each start point entity account vertex and a vertex indegree of each endpoint entity account vertex. For example, for the start point entity account vertex, a selection probability of the start point entity account vertex is determined based on a vertex outdegree of the start point entity account vertex divided by a total vertex outdegree of the start point entity account vertex set. The sum of selection probabilities of all start point entity account vertices in each start point entity account vertex set is 1. For the endpoint entity account vertex, a selection probability of the endpoint entity account vertex is determined based on a vertex indegree of the endpoint entity account vertex divided by a total vertex indegree of the endpoint entity account vertex set. The sum of selection probabilities of all endpoint entity account vertices in each endpoint entity account vertex set is 1. In an example, the vertex indegree used in a process of determining the selection probability is a vertex indegree in vertex attribute information of the endpoint entity account vertex. In another example, the vertex indegree used in a process of determining the selection probability is a vertex indegree obtained by removing a vertex indegree from the entity vertex from a vertex indegree in vertex attribute information of the endpoint entity account vertex.

After the selection probability of each start point entity account vertex and the selection probability of each endpoint entity account vertex are determined, in 220, at least one start point entity account vertex and a corresponding endpoint entity account vertex are selected from the start point entity account vertex set and the endpoint entity account vertex set based on the selection probability of each start point entity account vertex and the selection probability of each endpoint entity account vertex. Here, a process of selecting the entity account vertex is a random selection process based on the selection probability. The selected start point entity account vertex can include one or more start point entity account vertices, and each start point entity account vertex includes one corresponding endpoint entity account vertex.

In 230, an attribute distance between the selected start point entity account vertex and corresponding endpoint entity account vertex is calculated. For example, when there are a plurality of attributes of the same type between the selected start point entity account vertex and endpoint entity account vertex, attribute distances D between the plurality of attributes of the same type can be calculated. For example, if each of the selected start point entity account vertex and endpoint entity account vertex has a registration address, a registration phone, and a login network address, corresponding attribute distances D1 to D3 can be separately calculated based on the registration address, the registration phone, and the login network address.

In 240, a relationship creation probability between each selected start point entity account vertex and the corresponding endpoint entity account vertex is determined based on the calculated attribute distance. For example, the relationship creation probability can be determined by using a function relationship P=f(D) between the attribute distance D and the relationship creation probability P. When the attribute distance includes a plurality of attribute distances, in an example, an integrated attribute distance can be determined based on the plurality of attribute distances, and then the relationship creation probability can be determined based on the integrated attribute distance. Alternatively, the relationship creation probability can be determined based on a function relationship P=f(D₁, . . . , Dᵢ), where i is a quantity of attributes. Different weights can be further allocated for the attribute distances, and then the relationship creation probability can be determined based on the attribute distances and the weights of the attribute distances.

As described above, after the relationship creation probability between each start point entity account vertex and the corresponding endpoint entity account vertex is determined, in 250, an account association relationship is created between each selected start point entity account vertex and the corresponding endpoint entity account vertex based on the relationship creation probability. In this specification, the created account association relationship can include, for example, an account data transfer relationship, an account binding relationship, an account dependency relationship, and another type of association relationship that can occur between accounts. The account data transfer relationship can be, for example, an account data transfer behavior. For example, if the start point entity account vertex is “Zhang San”, and the endpoint entity account vertex is “Li Si”, an account data transfer relationship between the entity account vertices “Zhang San” and “Li Si” can be “Zhang San transfers XX yuan to Li Si on February 18”. In addition, compared with this account data transfer relationship, “Zhang San transfers XX yuan to Li Si on August 20” is another account data transfer relationship.

In an example, a plurality of account association relationships can be created between each selected start point entity account vertex and the corresponding endpoint entity account vertex based on the relationship creation probability, so that a quantity of created account association relationships reaches a predetermined quantity of account association relationships.

In another example, a process of creating the account association relationship can be a cycle process. Specifically, for each start point entity account vertex and corresponding endpoint entity account vertex, the relationship creation probability created in 240 is used as an initial relationship creation probability, and the following process is cyclically performed until no account association relationship is created: In each cycle, an account association relationship is created between the start point entity account vertex and the corresponding endpoint entity account vertex based on a current relationship creation probability. Then, it is determined whether an account association relationship is currently created. If an account association relationship is currently created, attenuation processing is performed on the relationship creation probability used in the current cycle process, to obtain a current relationship creation probability in a next cycle process, and then the next cycle process is performed. If no account association relationship is currently created, the cycle ends. For example, an example of the attenuation processing can include but is not limited to attenuation processing performed on the relationship creation probability based on a linear attenuation function or a nonlinear attenuation function. A function expression of the linear attenuation function or the nonlinear attenuation function can be any suitable function expression determined based on a specific application scenario.

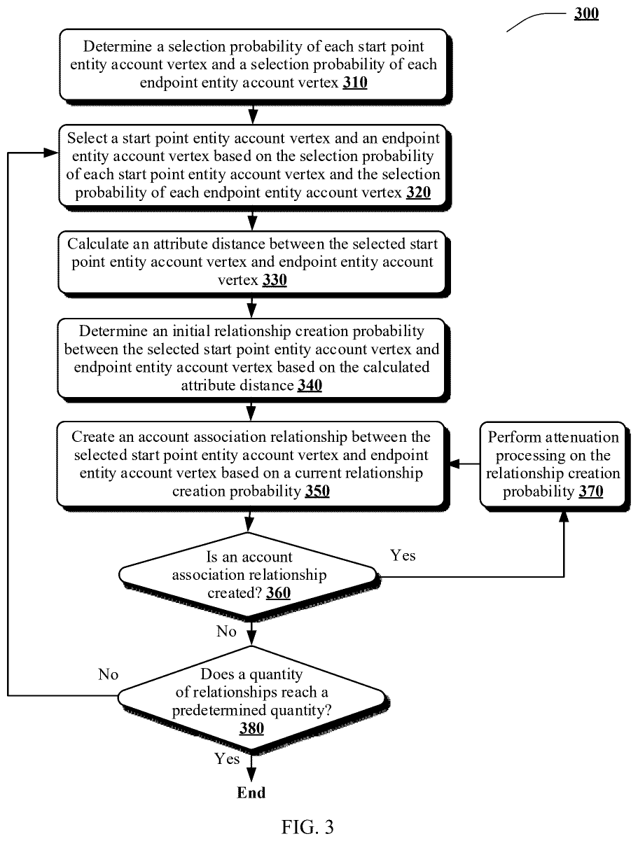

FIG. 3 is another example flowchart of an account association relationship creation process 300 according to a first embodiment of this specification. In an example in FIG. 3, an account vertex attribute of the entity account vertex includes a vertex outdegree and a vertex indegree.

In 310, a selection probability of each start point entity account vertex in the start point entity account vertex set and a selection probability of each endpoint entity account vertex in the endpoint entity account vertex set are determined based on a vertex outdegree of each start point entity account vertex and a vertex indegree of each endpoint entity account vertex. For a process of determining the selection probability, refer to the process described above with reference to FIG. 2.

As described above, after the selection probability of each start point entity account vertex and the selection probability of each endpoint entity account vertex are determined, 320 to 380 are cyclically performed until a quantity of created account association relationships reaches a predetermined quantity.

Specifically, in each cycle, in 320, at least one start point entity account vertex and a corresponding endpoint entity account vertex are selected from the start point entity account vertex set and the endpoint entity account vertex set based on the selection probability of each start point entity account vertex and the selection probability of each endpoint entity account vertex. Here, a process of selecting the entity account vertex is a random selection process based on the selection probability. The selected start point entity account vertex can include one or more start point entity account vertices, and each start point entity account vertex includes one corresponding endpoint entity account vertex.

In 330, an attribute distance between the selected start point entity account vertex and corresponding endpoint entity account vertex is calculated. For a process of calculating the attribute distance, refer to the process described above with reference to 230 in FIG. 2.

In 340, an initial relationship creation probability between each selected start point entity account vertex and the corresponding endpoint entity account vertex is determined based on the calculated attribute distance. For the initial relationship creation probability, refer to the process described above with reference to 240 in FIG. 2.

As described above, after the initial relationship creation probability between each start point entity account vertex and the corresponding endpoint entity account vertex is determined, for each start point entity account vertex and the corresponding endpoint entity account vertex, 350 to 370 are cyclically performed until no account association relationship is created.

Specifically, in each cycle, in 350, an account association relationship is created between each selected start point entity account vertex and the corresponding endpoint entity account vertex based on a current relationship creation probability. In the first cycle, the current relationship creation probability is the initial relationship creation probability. Then, in 360, it is determined whether an account association relationship is currently created. If an account association relationship is currently created, in 370, attenuation processing is performed on the relationship creation probability used in the current cycle process, to obtain a current relationship creation probability in a next cycle process, and then 350 is performed again to perform the next cycle process. If no account association relationship is currently created, the process proceeds to 380.

In 380, it is determined whether a quantity of created account association relationships reaches a predetermined quantity. If the predetermined quantity is reached, the process ends. If the predetermined quantity is not reached, 320 is performed again to perform the next cycle process.

In another example, in the account association relationship creation process shown in FIG. 2 or FIG. 3, the method can further include: obtaining vertex outdegree/indegree distribution information of the entity account vertex; and determining the vertex outdegree and the vertex indegree of each entity account vertex based on the obtained vertex outdegree/indegree distribution information.

In another example, in the account association relationship creation process shown in FIG. 2 or FIG. 3, the method can further include: obtaining social network outdegree/indegree distribution information; and creating a cognition/dependency relationship between the entity vertices based on the obtained social network outdegree/indegree distribution information. Then, when the relationship creation probability is determined, the relationship creation probability between the selected start point entity account vertex and endpoint entity account vertex is determined based on the calculated attribute distance and a cognition/dependency relationship between entity vertices to which the selected start point entity account vertex and endpoint entity account vertex respectively belong.

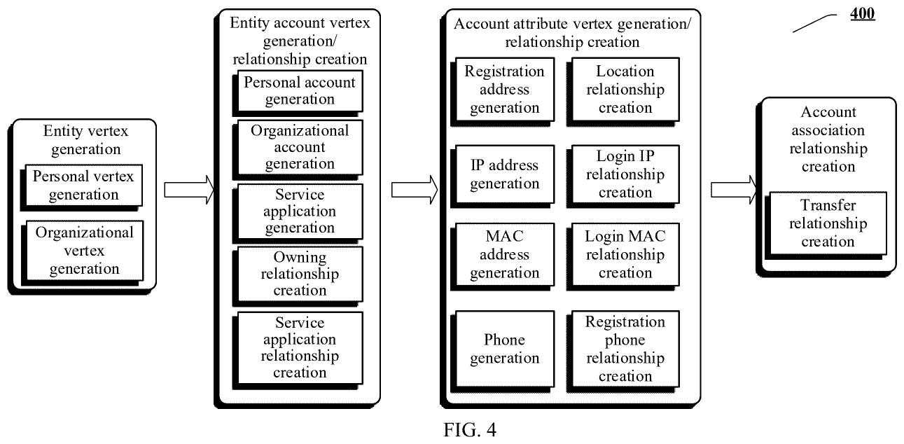

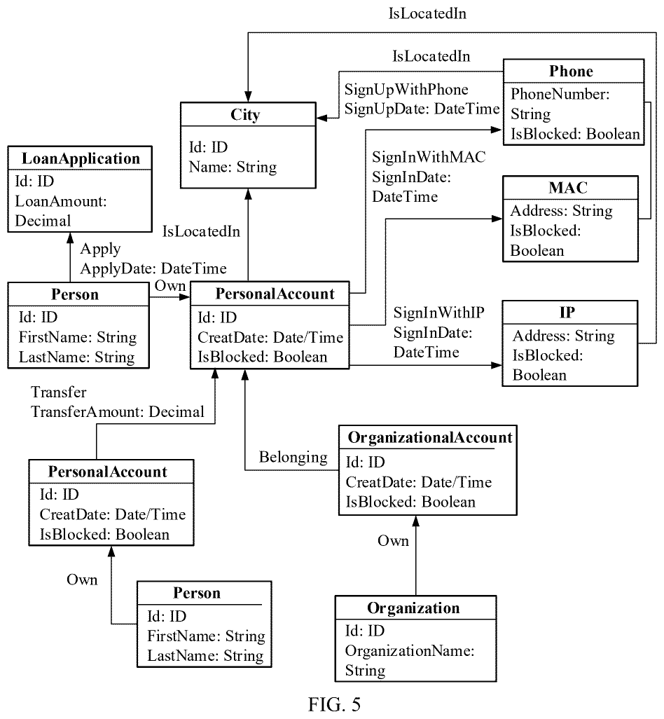

FIG. 4 is an example schematic diagram of a graph data generation process 400 according to an embodiment of this specification. FIG. 5 is an example schematic diagram of a data structure of graph data according to an embodiment of this specification.

As shown in FIG. 4, in the graph data generation process, an entity vertex, an entity account vertex, and an account attribute vertex are created at a vertex generation framework, and there are different mechanisms for creating the entity vertex, the entity account vertex, and the account attribute vertex. No data needs to be input to create the entity vertex. The created entity vertex needs to be input to create the entity account vertex. An account association attribute of the created entity account vertex needs to be input to create the account attribute vertex. In addition, at the vertex generation framework, an owning relationship between each entity account vertex and a corresponding entity vertex and an account attribute relationship between account attribute vertices and between each account attribute vertex and a corresponding entity account vertex are further separately created. At a vertex relationship generation framework, an account association relationship, for example, a transfer relationship (Transfer), between entity account vertices is created. As shown in FIG. 5, the transfer relationship has a relationship attribute TransferAmount. A value of TransferAmount is a decimal value.

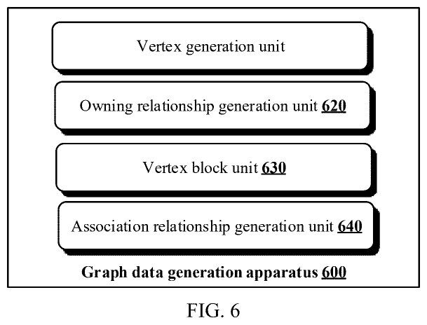

FIG. 6 is a block diagram of an apparatus 600 for generating graph data to be applied to a benchmark test according to a first embodiment of this specification. As shown in FIG. 6, the apparatus 600 includes a vertex generation unit 610, an owning relationship generation unit 620, a vertex block unit 630, and an association relationship generation unit 640.

The vertex generation unit 610 is configured to create a plurality of entity vertices and corresponding entity account vertices of the entity vertices. For an operation performed by the vertex generation unit 610, refer to the operation described above with reference to 110 in FIG. 1.

The owning relationship generation unit 620 is configured to create an owning relationship between the entity vertices and the corresponding entity account vertices. For an operation performed by the owning relationship generation unit 620, refer to the operation described above with reference to 120 in FIG. 1.

The vertex block unit 630 is configured to determine a start point entity account vertex set and an endpoint entity account vertex set based on the created entity account vertices. There is no overlapping entity account vertex between the start point entity account vertex set and the endpoint entity account vertex set. For an operation performed by the vertex block unit 630, refer to the operation described above with reference to 130 in FIG. 1.

The association relationship generation unit 640 is configured to create an account association relationship between the entity account vertices based on the start point entity account vertex set and the endpoint entity account vertex set. For an operation performed by the association relationship generation unit 640, refer to the operation described above with reference to the 140 in FIG. 1 and the operation described above with reference to FIG. 2 or FIG. 3.

In another example, the owning relationship generation unit 620 and the association relationship generation unit 640 can be implemented by using the same relationship generation unit.

In another example, the vertex block unit 630 can be further configured to extract a plurality of first entity vertices from the plurality of entity vertices. Then, the vertex generation unit 610 creates corresponding entity account vertices of the extracted first entity vertices.

In another example, the vertex generation unit 610 can be further configured to create service application vertices for the entity vertices. Correspondingly, the apparatus 600 can further include an application relationship generation unit (not shown). The application relationship generation unit is configured to create an application relationship (Apply) between each service application vertex and a corresponding entity vertex. The application relationship generation unit can be implemented by using the same unit as the owning relationship generation unit 620 and the association relationship generation unit 640, or can be implemented by using a different unit.

In another example, the apparatus 600 can further include a data distribution information obtaining unit (not shown). The data distribution information obtaining unit can be configured to obtain vertex outdegree distribution information of the entity vertices. Correspondingly, the vertex generation unit 610 creates the corresponding entity account vertices of the entity vertices based on the obtained vertex outdegree distribution information. The data distribution information obtained can be further configured to obtain vertex outdegree/indegree distribution information of the entity account vertex. Correspondingly, the vertex generation unit 610 determines a vertex outdegree and a vertex indegree of each entity account vertex based on the obtained vertex outdegree/indegree distribution information. The data distribution information obtaining unit can be further configured to obtain social network outdegree/indegree distribution information. Correspondingly, the apparatus 600 can further include an entity vertex relationship generation unit (not shown). The entity vertex relationship generation unit creates a cognition/dependency relationship between the entity vertices based on the obtained social network outdegree/indegree distribution information. Then, the association relationship generation unit 640 determines a relationship creation probability between a selected start point entity account vertex and endpoint entity account vertex based on a calculated attribute distance and a cognition/dependency relationship between entity vertices to which the selected start point entity account vertex and endpoint entity account vertex respectively belong. Similarly, the entity vertex relationship generation unit can be implemented by using the same unit as the application relationship generation unit, the owning relationship generation unit 620, and the association relationship generation unit 640, or can be implemented by using a different unit.

In the graph data generation solution shown in the first embodiment of this specification, test graph data having a real graph data structure can be generated, and is applied to a benchmark test. The graph data generation solution is particularly applicable to generation of financial graph data.

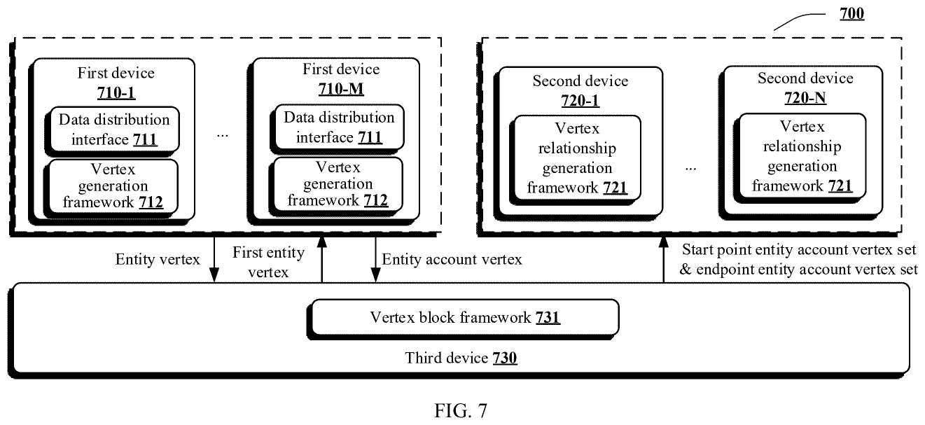

FIG. 7 is a block diagram of a system 700 for generating graph data to be applied to a benchmark test according to a second embodiment of this specification.

As shown in FIG. 7, the system 700 includes M first devices 710-1 to 710-M, N second devices 720-1 to 720-N, and a third device 730. Here, values of M and N can be the same or different. Specific values of M and N can be determined based on a specific application scenario, for example, can be determined based on a size of graph data that needs to be generated in an application scenario. The first device, the second device, and the third device can be any type of server devices or terminal devices that have a computing capability or a processing capability. For example, an example of the server device can include but is not limited to a single server, a server cluster, a cloud server, or a cloud server cluster. An example of the terminal device can include but is not limited to any one of intelligent terminal devices such as a smartphone, a personal computer (personal computer, PC), a notebook computer, a tablet computer, an electronic reader, a network television, and a wearable device.

The first device, the second device, and the third device can directly communicate with each other or perform data transmission through network communication. In some embodiments, the network can be any one or more of a wired network or a wireless network. For example, examples of the network can include but are not limited to a cable network, an optical fiber network, a telecommunication network, an enterprise intranet, the Internet, a local area network (LAN), a wide area network (WAN), a wireless local area network (WLAN), a metropolitan area network (MAN), a public switched telephone network (PSTN), a Bluetooth network, ZigBee, near field communication (NFC), an in-device bus, an in-device line, or any combination thereof.

A data distribution interface 711 and a vertex generation framework 712 can be deployed at each of the first devices 710-1 to 710-M. A vertex relationship generation framework 721 can be deployed at each of the second devices 720-1 to 720-N. A vertex block framework 731 can be deployed at the third device 730. In this specification, the term “framework” can be equivalent to “unit”, “module”, “platform”, or the like.

The data distribution interface 711 can be configured to obtain (for example, used by a user to input) vertex outdegree distribution information or vertex outdegree/indegree distribution information. Here, a vertex outdegree is a quantity of edges whose start point is the vertex; and a vertex indegree is a quantity of edges whose endpoint is the vertex. The vertex outdegree distribution information can be used by the vertex generation framework 712 to determine vertex outdegrees of created entity vertices. In addition, the data distribution interface 711 can be further configured to obtain vertex outdegree/indegree distribution information of an entity account vertex. Correspondingly, the vertex generation framework 712 determines a vertex outdegree and a vertex indegree of each entity account vertex based on the vertex outdegree/indegree distribution information of the entity account vertex. In addition, the data distribution interface 711 can be further configured to obtain social network outdegree/indegree distribution information. The obtained social network outdegree/indegree distribution information is used by the vertex generation framework 712 to create a cognition/dependency relationship between the created entity vertices.

Each of the first devices 710-1 to 710-M can correspond to each of a plurality of vertex blocks obtained by the vertex block framework 731 through grouping, and the vertex generation framework 712 at each first device is configured to process the vertex block received from the vertex block framework 731.

Specifically, the vertex generation framework 712 at each first device is configured to create a plurality of entity vertices. The entity vertices created by each vertex generation framework 712 can be sent to the vertex block framework 731, or can be stored in the same data storage space (data storage or data storage unit), so that the vertex block framework 731 obtains the entity vertex from the data storage space.

The vertex block framework 731 is configured to extract an entity vertex block from the created entity vertices for each vertex generation framework 712. Each vertex generation framework 712 corresponds to one entity vertex block, and each entity vertex block includes a plurality of first entity vertices. Here, entity vertex extraction performed by the vertex block framework 731 is random extraction without replacement, and during each time of extraction processing, all created entity vertices need to be extracted. For example, if all the vertex generation frameworks create 100 entity vertices, and there are 10 vertex generation frameworks, the vertex block framework 731 needs to perform random extraction processing for 10 times, and extract the 100 entity vertices into 10 entity vertex blocks. All the entity vertex blocks can include the same quantity or different quantities of entity vertices. In addition, during random extraction processing, an entity vertex extracted in previous extraction processing is no longer put back to an entity vertex pool of current extraction processing. For example, the extracted 10 entity vertex blocks can be distributed to all the vertex generation frameworks 712.

After each vertex generation framework 712 obtains the plurality of first entity vertices (entity vertex block) extracted by the vertex block framework 731, each vertex generation framework 712 is further configured to create corresponding entity account vertices for the first entity vertices based on obtained vertex outdegrees of the first entity vertices. In addition, in another example, each vertex generation framework 712 can further generate a service application vertex. A specific form of the service application vertex can be determined based on a specific application scenario. For example, in a financial application scenario, an example of the service application vertex can include a loan application (LoanApplication) vertex or a financing application vertex. Correspondingly, each vertex generation framework 712 is configured to create the corresponding entity account vertices and the service application vertices for the first entity vertices based on the obtained vertex outdegrees of the first entity vertices. Here, for example, the entity account vertex and the service application vertex can be collectively referred to as an entity-associated vertex. Similarly, the created entity account vertices can be sent to the vertex block framework 731, or can be stored in the same data storage space, so that the vertex block framework 731 obtains the entity account vertex from the data storage space.

As described above, after the entity account vertex is created, each vertex generation framework 712 is configured to create an owning relationship (Owe) between each entity account vertex and a corresponding first entity vertex. In another example, when each vertex generation framework 712 further creates a service application vertex, in addition to creating the owning relationship between each entity account vertex and the corresponding first entity vertex, each vertex generation framework 712 further creates an application relationship (Apply) between each service application vertex and a corresponding first entity vertex.

In addition, when each entity account vertex has an account association attribute, each vertex generation framework 712 is further configured to create an account attribute vertex based on the account association attribute of each entity account vertex; and create an account attribute relationship between account attribute vertices and between each account attribute vertex and a corresponding entity account vertex based on the account association attribute.

After each vertex generation framework 712 creates the entity account vertex, the vertex block framework 731 can be further configured to extract a start point entity account vertex set and an endpoint entity account vertex set from the created entity account vertices for each vertex relationship generation framework. Similarly, a process of extracting the start point entity account vertex set and the endpoint entity account vertex set by the vertex block framework 731 is extraction without replacement. In addition, the extraction process performed by the vertex block framework can end when all the entity account vertices are extracted.

After the start point entity account set and the endpoint entity account set are obtained, each vertex relationship generation framework 721 is configured to create an account association relationship between the entity account vertices based on the received start point entity account vertex set and endpoint entity account vertex set, to create required graph data. In an example, the graph data can be financial graph data, and the account association relationship can be a transfer relationship. A process of creating the account association relationship by the vertex relationship generation framework 721 is described in detail below with reference to the accompanying drawings.

In another embodiment of this specification, each first device may not include the data distribution interface 711.

In addition, in the example in FIG. 7, the first device, the second device, and the third device are shown as different devices. In another embodiment of this specification, some or each of the first devices 710-1 to 710-M can be the same as one of the second devices 720-1 to 720-N. That is, both a vertex generation framework and a vertex relationship generation framework can be deployed at one device. In another example, the third device 730 can be the same as one of the first devices 710-1 to 710-M and/or the second devices 720-1 to 720-N. That is, both a vertex generation framework and a vertex block framework, both a vertex relationship generation framework and a vertex block framework, or all of a vertex generation framework, a vertex relationship generation framework, and a vertex block framework can be deployed at one device.

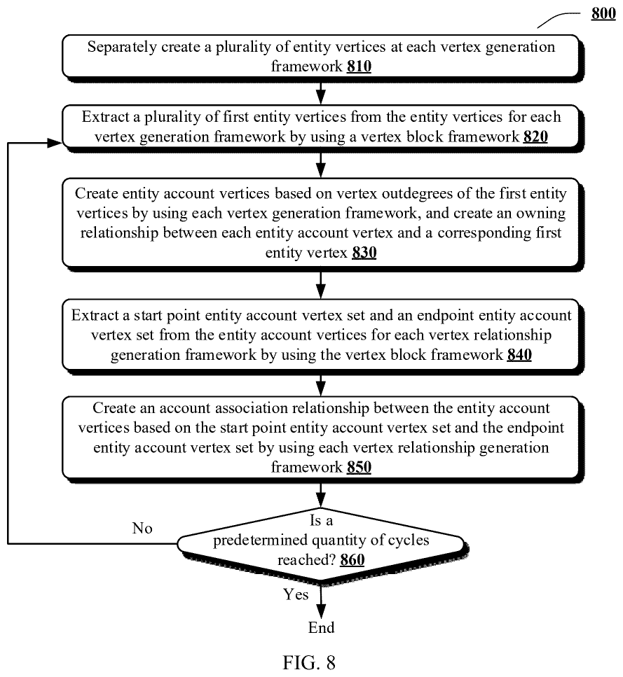

FIG. 8 is an example flowchart of a graph data generation method 800 according to an embodiment of this specification.

As shown in FIG. 8, in 810, a plurality of entity vertices are separately created at a vertex generation framework at each first device. In an example, an entity vertex attribute of each entity vertex can include a vertex outdegree. Here, vertex outdegrees of the entity vertices can be determined based on vertex outdegree distribution information obtained by using a data distribution interface at the first device at which the vertex generation framework is located. In an example, the created entity vertices can be sent to a vertex block framework, or can be stored in common data storage space for obtaining by a vertex block framework. When an entity vertex attribute of the entity vertex includes a vertex outdegree and a vertex indegree, vertex outdegree/indegree distribution information can be obtained by using a data distribution interface at the first device at which the vertex generation framework is located.

After each vertex generation framework creates the entity vertices, an operation process from 820 to 860 is cyclically performed until the process is cyclically performed for a predetermined quantity of times, for example, K times.

Specifically, in each cycle process, in 820, the vertex block framework at a third device extracts an entity vertex block from the created entity vertices for each vertex generation framework. Each vertex generation framework corresponds to one entity vertex block, and each entity vertex block includes a plurality of first entity vertices. When the vertex block framework and the vertex generation framework are located at different device bodies, a plurality of first entity vertex blocks extracted by the vertex block framework can be distributed to corresponding vertex generation frameworks. It should be noted that in each cycle process, an entity vertex used for entity vertex extraction includes all the entity vertices created in step 810. In addition, an entity vertex extraction process performed by the vertex block framework uses the entity vertex extraction process described above with reference to FIG. 7.

In 830, at each vertex generation framework, corresponding entity account vertices are separately created for the first entity vertices based on vertex outdegrees of the extracted first entity vertices, and an owning relationship is created between each entity account vertex and a corresponding entity vertex. In an example, the created entity account vertices can be sent to the vertex block framework, or can be stored in common data storage space for obtaining by the vertex block framework.

In 840, the vertex block framework extracts a start point entity account vertex set and an endpoint entity account vertex set from the created entity account vertices for each vertex relationship generation framework.

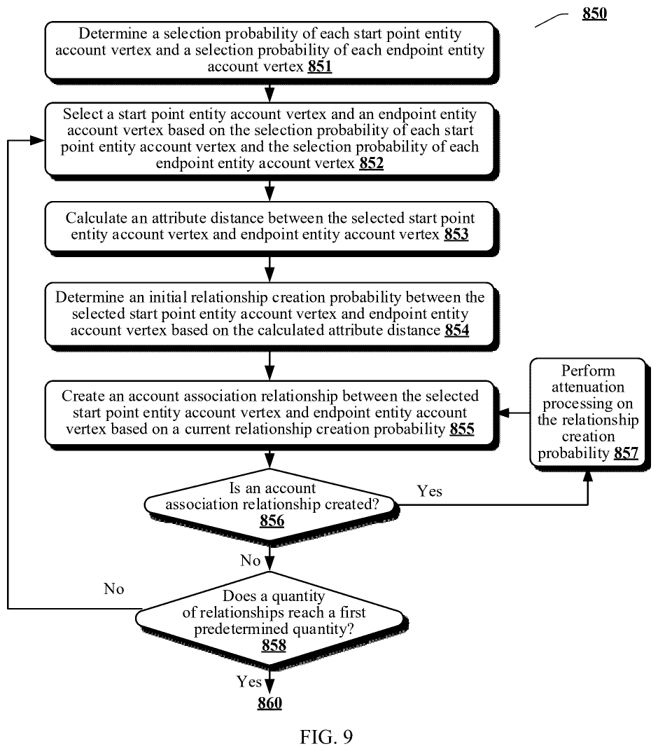

In 850, at each vertex relationship generation framework, an account association relationship between the entity account vertices is separately created based on the extracted start point entity account vertex set and endpoint entity account vertex set. A process of creating the account association relationship is described in detail below with reference to FIG. 9.

In 860, it is determined whether a predetermined quantity (for example, K) of cycles is reached. If the predetermined quantity of cycles is reached, the process ends. If the predetermined quantity of cycles is not reached, 820 is performed again to perform a next cycle process.

The graph data generation method described in FIG. 8 can be modified in a modification manner corresponding to a modification to the graph data generation method described in FIG. 1.

FIG. 9 is an example flowchart of an account association relationship creation process 850 according to an embodiment of this specification. The account association relationship creation process is a process performed by a single vertex relationship generation framework.

As shown in FIG. 8, in 851, a selection probability of each start point entity account vertex in the start point entity account vertex set and a selection probability of each endpoint entity account vertex in the endpoint entity account vertex set are determined based on a vertex outdegree of each start point entity account vertex and a vertex indegree of each endpoint entity account vertex.

As described above, after the selection probability of each start point entity account vertex and the selection probability of each endpoint entity account vertex are determined, 852 to 858 are cyclically performed until a quantity of created account association relationships reaches a first predetermined quantity M. In an example, when an entity vertex extraction process performed by the vertex block framework and an account association relationship creation process performed by each vertex relationship generation framework are cyclically performed for K times, the first predetermined quantity is M=P/K, where P is a total quantity of outdegrees of the plurality of created entity account vertices (all entity account vertices). In another example, P can alternatively be a predetermined value that is preset to indicate a total quantity of account association relationships that need to be created.

Specifically, in each cycle process, in 852, at least one start point entity account vertex and a corresponding endpoint entity account vertex are selected from the start point entity account vertex set and the endpoint entity account vertex set based on the selection probability of each start point entity account vertex and the selection probability of each endpoint entity account vertex. In an example, one start point entity account vertex and one endpoint entity account vertex are selected each time. In another example, a plurality of start point entity account vertices and corresponding endpoint entity account vertices can be selected each time. Here, a process of selecting the entity account vertex is a random selection process based on the selection probability.

In 853, an attribute distance between the selected start point entity account vertex and endpoint entity account vertex is calculated. For a process of calculating the attribute distance, refer to the process described above with reference to 230 in FIG. 2.

In 854, an initial relationship creation probability between the selected start point entity account vertex and endpoint entity account vertex is determined based on the calculated attribute distance D. For a process of determining the initial relationship creation probability, refer to the process described above with reference to 240 in FIG. 2.

Then, 855 to 857 are cyclically performed until no new account association is created. In 855, an account association relationship is created between the selected start point entity account vertex and endpoint entity account vertex based on a current relationship creation probability. In 856, it is determined whether an account association relationship is currently created. If an account association relationship is currently created, in 857, attenuation processing is performed on the relationship creation probability used in the current cycle process, to obtain a current relationship creation probability in a next cycle process, and then 855 is performed again to perform the next cycle process.

If no account association relationship is currently created, 858 is performed. In 858, it is determined whether a quantity of created account association relationships reaches a first predetermined quantity M. If the first predetermined quantity M is reached, the process proceeds to 860 in FIG. 8. If the first predetermined quantity M is not reached, 852 is performed again to perform the next cycle process.

As described above, the graph data generation method according to the second embodiment of this specification is described with reference to FIG. 7 to FIG. 9. It should be noted that the foregoing embodiments described with reference to the accompanying drawings are merely examples. In another embodiment, various adaptive modifications to the foregoing embodiments can be further made.

For example, in another embodiment, social network outdegree/indegree distribution information can be further obtained by using a corresponding data distribution interface of each vertex generation framework. Then, at each vertex generation framework, a cognition/dependency relationship is created between the entity vertices based on the obtained social network outdegree/indegree distribution information. For example, a cognition/dependency relationship is created between personal vertices and/or organizational vertices. Correspondingly, when the initial relationship creation probability is determined, in addition to considering the attribute distance between the selected start point entity account vertex and endpoint entity account vertex, a cognition/dependency relationship between entity vertices to which the selected start point entity account vertex and endpoint entity account vertex respectively belong needs to be considered. That is, the initial relationship creation probability between the selected start point entity account vertex and endpoint entity account vertex is determined based on the calculated attribute distance and the cognition/dependency relationship between the entity vertices to which the selected start point entity account vertex and endpoint entity account vertex respectively belong.

In addition, in the example in FIG. 9, a process of creating the account association relationship based on the relationship creation probability is shown as a cycle process. In another embodiment, a plurality of account association relationships can be created at once without performing a cycle process.

A graph data generation process according to the second embodiment of this specification is described below with reference to an example.

In this example, it is assumed that there are 10 vertex generation frameworks, 10 vertex relationship generation frameworks, and one vertex block framework. After the 10 vertex generation frameworks generate a total of 100 entity vertices, five cycle processes are performed to generate graph data. In each cycle, the vertex block framework randomly groups all the 100 entity vertices into 10 entity vertex blocks, and each entity vertex block includes 10 entity vertices. Then, the vertex block framework distributes one entity vertex block to each vertex generation framework. After receiving the entity vertex block, each vertex generation framework creates a corresponding entity account vertex based on a vertex outdegree of each entity vertex, and creates an owning relationship between the created entity account vertex and the corresponding entity vertex.

Subsequently, the vertex block framework randomly groups all created entity account vertices into 10 entity account blocks, and each entity account block includes one start point entity account vertex set and one endpoint entity account vertex set. There is no common entity account vertex between entity account vertex sets obtained through grouping. Then, the vertex block framework distributes one entity account vertex block to each vertex relationship generation framework. After receiving the entity account vertex block, each vertex relationship generation framework creates an account association relationship between the entity account vertices based on the start point entity account vertex set and the endpoint entity account vertex set. This is repeated for five times until a predetermined quantity of account association relationships are created.

In the graph data generation solution according to the second embodiment of this specification, a vertex generation process and a vertex relationship generation process are distributed to a plurality of vertex generation frameworks and a plurality of vertex relationship generation frameworks for execution, so that graph data of any data size can be easily generated. In addition, in the graph data generation solution, the vertex generation process, the vertex relationship generation process, and an attribute relationship generation process that are related to an application scenario, and a vertex block process that is not related to the application scenario are deployed at different processing frameworks, to decouple the vertex generation process, the vertex relationship generation process, and the attribute relationship generation process that are related to the application scenario from the data block process that is not related to the application scenario, so that it is possible to modify and extend the application scenario. Furthermore, when the account association relationship is created, the start point entity account vertex set and the endpoint entity account vertex set are extracted from the created entity account vertices for each vertex relationship generation framework. This extraction process is random extraction, to ensure that a relationship can be generated between vertices in blocks.

In addition, in the graph data generation solution, when the account association relationship is created, the initial relationship creation probability is determined, the account association relationship is created based on the initial relationship creation probability, and after the account association relationship is created, the initial relationship creation probability is attenuated to further create the account association relationship. This is repeated for a plurality of times, so that the created account association relationship more conforms to an actual application scenario.

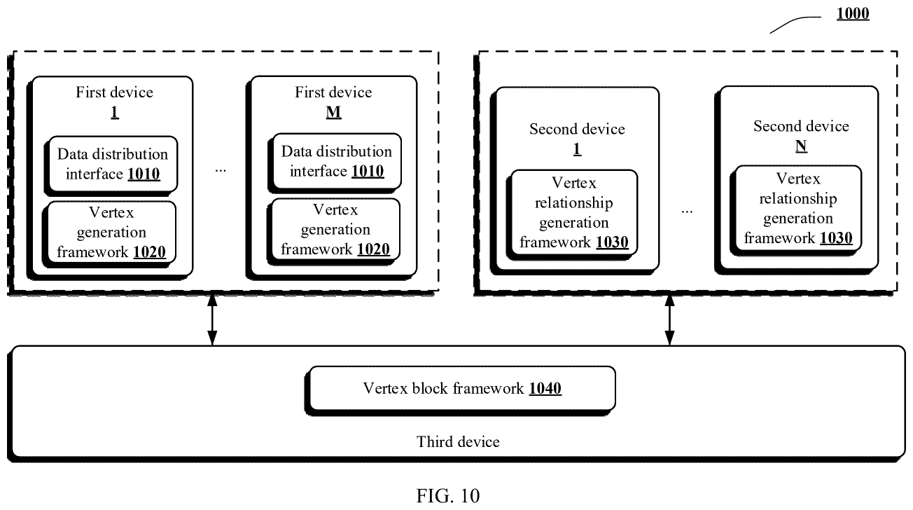

FIG. 10 is a block diagram of a graph data generation apparatus 1000 according to an embodiment of this specification. As shown in FIG. 10, the graph data generation apparatus 1000 includes a plurality of (for example, M) data distribution interfaces 1010, a plurality of (for example, M) vertex generation frameworks 1020, a plurality of (for example, N) vertex relationship generation frameworks 1030, and a vertex block framework 1040. Here, values of M and N can be the same or different. Each data distribution interface 1010 and one vertex generation framework 1020 are deployed at one first device, and each vertex relationship generation framework 1030 is deployed at one second device. The vertex block framework 1040 is deployed at a third device.

The data distribution interface 1010 is configured to obtain vertex outdegree distribution information of entity vertices. Each vertex generation framework 1020 is configured to create a plurality of entity vertices. An entity vertex attribute of each entity vertex includes a vertex outdegree, and vertex outdegrees of the entity vertices can be determined based on the obtained vertex outdegree distribution information.

The vertex block framework 1040 is configured to extract a plurality of first entity vertices from the created entity vertices for each vertex generation framework. Then, each vertex generation framework 1020 is further configured to create corresponding entity account vertices for the first entity vertices based on vertex outdegrees of the first entity vertices extracted by the vertex block framework, and create an owning relationship between each entity account vertex and a corresponding first entity vertex.

The vertex block framework 1040 is further configured to extract a start point entity account vertex set and an endpoint entity account vertex set from the created entity account vertices for each vertex relationship generation framework.

Each vertex relationship generation framework 1030 is configured to create an account association relationship between the entity account vertices based on the extracted start point entity account vertex set and endpoint entity account vertex set.

The data distribution interface 1010 can be further configured to obtain vertex outdegree/indegree distribution information of the entity account vertex. Correspondingly, each vertex generation framework 1020 can determine a vertex outdegree and a vertex indegree of each entity account vertex based on the obtained vertex outdegree/indegree distribution information.

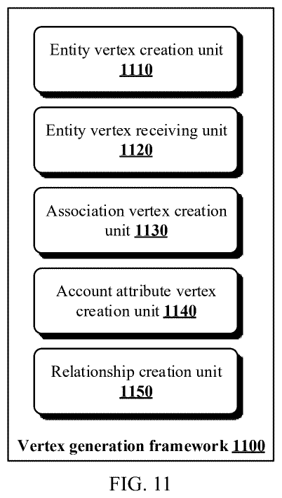

FIG. 11 is an example block diagram of a vertex generation framework 1100 according to an embodiment of this specification. As shown in FIG. 11, the vertex generation framework 1100 includes an entity vertex creation unit 1110, an entity vertex receiving unit 1120, an associated vertex creation unit 1130, an account attribute vertex creation unit 1140, and a relationship creation unit 1150.

The entity vertex creation unit 1110 is configured to create a plurality of entity vertices. In an example, vertex outdegree distribution information of the entity vertices can be obtained by using a data distribution interface, and the entity vertex creation unit 1110 can determine vertex outdegrees of the entity vertices based on the obtained vertex distribution information.

After a vertex block framework performs entity vertex extraction on the plurality of created entity vertices, the entity vertex receiving unit 1120 is configured to receive a plurality of corresponding first entity vertices from the vertex block framework. When the vertex block framework and the vertex generation framework are located at the same device body, the entity vertex receiving unit 1120 may not be required.

The associated vertex creation unit 1130 is configured to create corresponding entity account vertices for the first entity vertices based on vertex outdegrees of the first entity vertices received from the vertex block framework. The relationship creation unit 1150 is configured to create an owning relationship between the created entity account vertices and the corresponding entity vertices.

In addition, when there is a service application vertex, the associated vertex creation unit 1130 is configured to create the corresponding entity account vertices and service application vertices for the first entity vertices based on the vertex outdegrees of the first entity vertices received from the vertex block framework. Correspondingly, the relationship creation unit 1150 is configured to create an owning relationship between the created entity account vertex and the corresponding entity vertex, and create an application relationship between each service application vertex and a corresponding entity vertex.

When the entity account vertex has an account association attribute, the account attribute vertex creation unit 1140 is configured to create an account attribute vertex based on an account association attribute of each entity account vertex. Correspondingly, the relationship creation unit 1150 is configured to create an account attribute relationship between account attribute vertices and between each account attribute vertex and a corresponding entity account vertex based on the account association attribute. When the entity account vertex does not have an account association attribute, the account attribute vertex creation unit 1140 may not be required.

It should be noted that in another embodiment, some or all of the entity vertex creation unit 1110, the associated vertex creation unit 1130, and the account attribute vertex creation unit 1140 can be implemented by using the same unit.

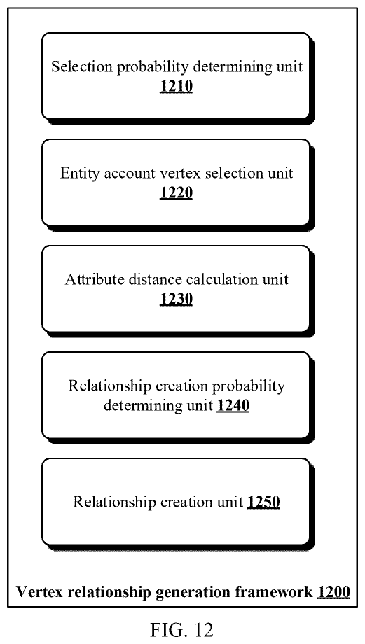

FIG. 12 is an example block diagram of a vertex relationship generation framework 1200 according to an embodiment of this specification. As shown in FIG. 12, the vertex relationship generation framework 1200 includes a selection probability determining unit 1210, an entity account vertex selection unit 1220, an attribute distance calculation unit 1230, a relationship creation probability determining unit 1240, and a relationship creation unit 1250.

The selection probability determining unit 1210 is configured to determine a selection probability of each start point entity account vertex in a start point entity account vertex set and a selection probability of each endpoint entity account vertex in an endpoint entity account vertex set based on a vertex outdegree of each start point entity account vertex and a vertex indegree of each endpoint entity account vertex.

The entity account vertex selection unit 1220, the attribute distance calculation unit 1230, the relationship creation probability determining unit 1240, and the relationship creation unit 1250 cyclically perform an operation until a quantity of created account association relationships reaches a first predetermined quantity M.

Specifically, in each cycle process, the entity account vertex selection unit 1220 is configured to select at least one start point entity account vertex and a corresponding endpoint entity account vertex from the start point entity account vertex set and the endpoint entity account vertex set based on the selection probability of each start point entity account vertex and the selection probability of each endpoint entity account vertex.

The attribute distance calculation unit 1230 is configured to calculate an attribute distance between the selected start point entity account vertex and endpoint entity account vertex.

The relationship creation probability determining unit 1240 is configured to determine an initial relationship creation probability between the selected start point entity account vertex and endpoint entity account vertex based on the calculated attribute distance.

The relationship creation unit 1250 is configured to cyclically perform the following process until no new account association relationship is created: creating an account association relationship between the selected start point entity account vertex and endpoint entity account vertex based on a current relationship creation probability. A relationship creation probability used in each cycle process is obtained by performing attenuation processing on a relationship creation probability in a previous cycle process.

In addition, a data distribution interface can be configured to obtain social network outdegree/indegree distribution information. In this case, the relationship creation unit 1250 can be configured to create a cognition/dependency relationship between entity vertices based on the obtained social network outdegree/indegree distribution information. In addition, the relationship creation probability determining unit 1240 is configured to determine the initial relationship creation probability between the selected start point entity account vertex and endpoint entity account vertex based on the calculated attribute distance and a cognition/dependency relationship between entity vertices to which the selected start point entity account vertex and endpoint entity account vertex respectively belong.

In this specification, in an example, there can be a one-to-one correspondence between a vertex generation framework and the vertex relationship generation framework. When there is a one-to-one correspondence between the vertex generation framework and the vertex relationship generation framework, the vertex generation framework can be deployed at the same device as the corresponding vertex relationship generation framework. In this case, the relationship creation unit 1150 can alternatively be used as a component of the vertex relationship generation framework and included in the vertex relationship generation framework, but is not used as a component of the vertex generation framework.

As described above, the graph data generation method, apparatus, and system according to the embodiment of this specification are described with reference to FIG. 1 to FIG. 12. The graph data generation apparatus can be implemented by using hardware, or can be implemented by using software or a combination of hardware and software.

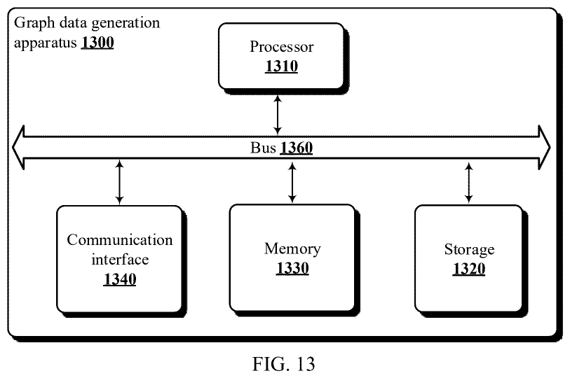

FIG. 13 is a schematic diagram of a graph data generation apparatus 1300 implemented based on a computer system according to an embodiment of this specification. As shown in FIG. 13, the graph data generation apparatus 1300 can include at least one processor 1310, a storage (for example, a nonvolatile storage) 1320, a memory 1330, and a communication interface 1340. The at least one processor 1310, the storage 1320, the memory 1330, and the communication interface 1340 are connected together by using a bus 1360. The at least one processor 1310 executes at least one computer-readable instruction (namely the foregoing element implemented in a software form) stored or encoded in the storage.

In an embodiment, computer-executable instructions are stored in the storage. When the instructions are executed, the at least one processor 1310 is enabled to perform the following operations: creating a plurality of entity vertices and corresponding entity account vertices of the entity vertices; creating an owning relationship between the entity vertices and the corresponding entity account vertices; determining a start point entity account vertex set and an endpoint entity account vertex set based on the created entity account vertices, where there is no overlapping entity account vertex between the start point entity account vertex set and the endpoint entity account vertex set; and creating an account association relationship between the entity account vertices based on the start point entity account vertex set and the endpoint entity account vertex set.

In another embodiment, computer-executable instructions are stored in the storage. When the instructions are executed, the at least one processor 1310 is enabled to perform the following operations: separately creating a plurality of entity vertices by using each vertex generation framework; extracting a plurality of first entity vertices from the created entity vertices for each vertex generation framework by using a vertex block framework; separately creating corresponding entity account vertices of the extracted first entity vertices by using each vertex generation framework, and creating an owning relationship between each entity account vertex and a corresponding entity vertex; extracting a start point entity account vertex set and an endpoint entity account vertex set from the created entity account vertices for each vertex relationship generation framework by using the vertex block framework; and separately creating an account association relationship between the entity account vertices based on the extracted start point entity account vertex set and endpoint entity account vertex set by using each vertex relationship generation framework.

It should be understood that when the computer-executable instructions stored in the storage are executed, the at least one processor 1310 is enabled to perform the operations and functions described above with reference to FIG. 1 to FIG. 12 in the embodiments of this specification.

According to an embodiment, a program product such as a machine-readable medium (for example, a non-temporary machine-readable medium) is provided. The machine-readable medium can have instructions (namely, the foregoing element implemented in a software form). When the instructions are executed by a machine, the machine is enabled to perform the operations and functions described above with reference to FIG. 1 to FIG. 12 in the embodiments of this specification. Specifically, a system or an apparatus in which a readable storage medium is disposed can be provided, and software program code for implementing a function in any one of the foregoing embodiments is stored in the readable storage medium, so that a computer or a processor of the system or the apparatus reads and executes instructions stored in the readable storage medium.

In this case, the program code read from the readable medium can implement the function in any one of the foregoing embodiments. Therefore, the machine-readable code and the readable storage medium that stores the machine-readable code form a part of this specification.

Embodiments of the readable storage medium include a floppy disk, a hard disk, a magneto-optical disc, an optical disc (for example, a CD-ROM, a CD-R, a CD-RW, a DVD-ROM, a DVD-RAM, a DVD-RW, and a DVD-RW), a magnetic tape, a nonvolatile storage card, and a ROM. Alternatively, program code can be downloaded from a server computer or cloud through a communication network.

According to an embodiment, a computer program product is provided. The computer program product includes a computer program. When the computer program is executed by a processor, the processor is enabled to perform the operations and functions described above with reference to FIG. 1 to FIG. 12 in the embodiments of this specification.

A person skilled in the art should understand that various variations and modifications to the embodiments disclosed above can be made without departing from the essence of this specification. Therefore, the protection scope of this specification shall be limited by the appended claims.

It should be noted that not all the steps and units in the foregoing processes and system structural diagrams are required, and some steps or units can be ignored based on an actual requirement. An execution sequence of the steps is not fixed, and can be determined based on a requirement. The apparatus structure described in the foregoing embodiments can be a physical structure, or can be a logical structure, that is, some units may be implemented by a same physical entity, or some units can be implemented by a plurality of physical entities, or can be jointly implemented by some components in a plurality of independent devices.

In the foregoing embodiments, the hardware unit or the module can be implemented in a mechanical form or an electrical form. For example, the hardware unit, the module, or the processor can include a permanent dedicated circuit or logic (for example, a dedicated processor, an FPGA, or an ASIC) to complete a corresponding operation. The hardware unit or the processor can further include a programmable logic or circuit (for example, a general-purpose processor or another programmable processor), and can be temporarily set by software to complete a corresponding operation. A specific implementation (a mechanical form, a dedicated permanent circuit, or a circuit that is temporarily set) can be determined based on cost and time considerations.

The example embodiments are described above with reference to the specific implementations described in the accompanying drawings, but do not represent all embodiments that can be implemented or fall within the protection scope of the claims. The term “example” used throughout this specification means “used as an example, an instance, or an illustration”, and does not mean “preferred” or “advantageous” over other embodiments. For the purpose of providing an understanding of the described technology, the specific implementations include specific details. However, these technologies can be implemented without these specific details. In some instances, well-known structures and apparatuses are shown in block diagram forms, to avoid difficulty in understanding the concept in the described embodiments.

The foregoing descriptions of this disclosure are provided to enable any person of ordinary skill in the art to implement or use this disclosure. It is clear to a person of ordinary skill in the art that various modifications are made to this disclosure. In addition, the general principle defined in this specification can be applied to another variant without departing from the protection scope of this disclosure. Therefore, this disclosure is not limited to the examples and designs described in this specification, but is consistent with the widest range that conforms to principles and novel features disclosed in this specification.

1. A method for generating graph data to be applied to a benchmark test, comprising:
creating a plurality of entity vertices and corresponding entity account vertices of the entity vertices;
creating an owning relationship between the entity vertices and the corresponding entity account vertices;
determining a start point entity account vertex set and an endpoint entity account vertex set based on the created entity account vertices, wherein there is no overlapping entity account vertex between the start point entity account vertex set and the endpoint entity account vertex set; and
creating an account association relationship between the entity account vertices based on the start point entity account vertex set and the endpoint entity account vertex set.

2. The method according to claim 1, wherein an account vertex attribute of each entity account vertex comprises an account association attribute, and the method further comprises:
creating an account attribute vertex based on the account association attribute of each entity account vertex; and
creating an account attribute relationship between account attribute vertices and/or between each account attribute vertex and a corresponding entity account vertex based on the account association attribute.

3. The method according to claim 2, wherein the entity vertex comprises a personal vertex and an organizational vertex, the entity account vertex comprises a personal account vertex and an organizational account vertex, and the account attribute vertex comprises at least one of an account registration address, a registration phone, a login network address, and a login physical address; and
the account attribute relationship comprises at least one of a location relationship, a phone registration relationship, a login network address relationship, and a login physical address relationship.

4. The method according to claim 1, further comprising:
obtaining vertex outdegree distribution information of the entity vertices; and
creating corresponding entity account vertices of the entity vertices comprises:
creating the corresponding entity account vertices of the entity vertices based on the vertex outdegree distribution information.

5. The method according to claim 1, wherein an account vertex attribute of each entity account vertex comprises a vertex outdegree and a vertex indegree, and the creating an account association relationship between the entity account vertices based on the start point entity account vertex set and the endpoint entity account vertex set comprises:
determining a selection probability of each start point entity account vertex in the start point entity account vertex set and a selection probability of each endpoint entity account vertex in the endpoint entity account vertex set based on a vertex outdegree of each start point entity account vertex and a vertex indegree of each endpoint entity account vertex;
selecting at least one start point entity account vertex and a corresponding endpoint entity account vertex from the start point entity account vertex set and the endpoint entity account vertex set based on the selection probability of each start point entity account vertex and the selection probability of each endpoint entity account vertex;
calculating an attribute distance between the selected start point entity account vertex and corresponding endpoint entity account vertex;
determining a relationship creation probability between the selected start point entity account vertex and corresponding endpoint entity account vertex based on the calculated attribute distance; and
creating an account association relationship between the selected start point entity account vertex and corresponding endpoint entity account vertex based on the relationship creation probability.

6. The method according to claim 5, wherein a process of creating the account association relationship is cyclically performed until no new account association relationship is created, and a relationship creation probability used in each cycle process is obtained by performing attenuation processing on a relationship creation probability in a previous cycle process.

7. The method according to claim 5, wherein a process of selecting the start point entity account vertex and the corresponding endpoint entity account vertex and a process of creating the account association relationship are cyclically performed until a quantity of created account association relationships reaches a predetermined quantity.

8. The method according to claim 5, further comprising:
obtaining vertex outdegree/indegree distribution information of the entity account vertex; and
determining the vertex outdegree and the vertex indegree of each entity account vertex based on the vertex outdegree/indegree distribution information.

9. The method according to claim 5, further comprising:
obtaining social network outdegree/indegree distribution information; and
creating a cognition/dependency relationship between the entity vertices based on the social network outdegree/indegree distribution information; and
determining a relationship creation probability between the selected start point entity account vertex and endpoint entity account vertex based on the calculated attribute distance comprises:
determining the relationship creation probability between the selected start point entity account vertex and endpoint entity account vertex based on the calculated attribute distance and a cognition/dependency relationship between entity vertices to which the selected start point entity account vertex and endpoint entity account vertex respectively belong.

10. The method according to claim 4, wherein creating the corresponding entity account vertices of the plurality of entity vertices based on the vertex outdegree distribution information comprises:
creating the corresponding entity account vertices and service application vertices of the entity vertices based on the vertex outdegree distribution information; and
creating an application relationship between each service application vertex and a corresponding entity vertex.

11. The method according to claim 1, further comprising:
extracting a plurality of first entity vertices from the plurality of entity vertices; and
creating corresponding entity account vertices of the entity vertices comprises:
creating corresponding entity account vertices of the first entity vertices.

12-21. (canceled)

22. (canceled)

23. (canceled)

24. (canceled)

25. (canceled)

26. (canceled)

27. (canceled)

28. (canceled)

29. A system for generating graph data to be applied to a benchmark test, comprising:
at least two first devices, wherein a vertex generation framework is deployed at each first device;
at least two second devices, wherein a vertex relationship generation framework is deployed at each second device; and
a third device at which a vertex block framework is deployed, wherein
each vertex generation framework is configured to:
create a plurality of entity vertices;
create corresponding entity account vertices of first entity vertices extracted by the vertex block framework; and
create an owning relationship between each entity account vertex and a corresponding entity vertex;
the vertex block framework is configured to extract the plurality of first entity vertices from the created entity vertices for each vertex generation framework; and extract a start point entity account vertex set and an endpoint entity account vertex set from the created entity account vertices for each vertex relationship generation framework; and
each vertex relationship generation framework is configured to create an account association relationship between the entity account vertices based on the extracted start point entity account vertex set and endpoint entity account vertex set.

30. An apparatus for generating graph data to be applied to a benchmark test comprising a memory and a processor, wherein the memory stores executable instructions that, in response to execution by the processor, cause the processor to:
create a plurality of entity vertices and corresponding entity account vertices of the entity vertices;
create an owning relationship between the entity vertices and the corresponding entity account vertices;
determine a start point entity account vertex set and an endpoint entity account vertex set based on the created entity account vertices, wherein there is no overlapping entity account vertex between the start point entity account vertex set and the endpoint entity account vertex set; and
create an account association relationship between the entity account vertices based on the start point entity account vertex set and the endpoint entity account vertex set.

31. A non-transitory computer-readable storage medium comprising instructions stored therein that, when executed by a processor of a computing device, cause the processor to:
create a plurality of entity vertices and corresponding entity account vertices of the entity vertices;
create an owning relationship between the entity vertices and the corresponding entity account vertices;
determine a start point entity account vertex set and an endpoint entity account vertex set based on the created entity account vertices, wherein there is no overlapping entity account vertex between the start point entity account vertex set and the endpoint entity account vertex set; and
create an account association relationship between the entity account vertices based on the start point entity account vertex set and the endpoint entity account vertex set.

32. (canceled)
